(19) United States
(12) Patent Application Publication
(10) Pub. No.: US 2008/0040155 A1
(43) Pub. Date: Feb. 14, 2008

(54) Method and system for providing multiple funding sources for health insurance and other expenditures

(75) Inventors: Randall E. Ray, Olympia, WA (US); Robert A. Payton, Camano Island, WA (US)

Correspondence Address: ARENT FOX LLP, 1050 CONNECTICUT AVENUE, N.W., SUITE 400, WASHINGTON, DC, 20036, US

(73) Assignee: Dominium Intellectual Property Inc.

(21) Appl. No.: 11/882,899

(22) Filed: Aug. 7, 2007

Related U.S. Application Data
(60) Provisional application No. 60/836,089, filed on Aug. 7, 2006.

(51) Int. Cl. G06Q 40/00; G06Q 50/00

(52) U.S. Cl. 705/2

(57) ABSTRACT

Methods and systems for providing multiple funding sources for health insurance and other approved healthcare expenses to full-time, hourly, part-time, seasonal, and temporary employees. Healthcare contributions for a single employee or for multiple workers in a family from more than one employer are placed in trust accounts established under separate Health Reimbursement Arrangements (HRAs) by each employer for use in paying qualified medical expenses of the employee and/or the employees' family. Each employer agrees to create HRAs for eligible employees and sends eligible employee data to a financial administrator. A trust account is created to hold the employer contributed HRA funds for the eligible employees. The eligible employees select a healthcare insurance policy, the premiums for which are paid out of each employee's HRA. The employee retains the HRA even if the employee's employment with the funding employer is terminated.

### CROSS-REFERENCE TO RELATED APPLICATIONS

This application claims the benefit of U.S. Provisional Patent Application Ser. No. 60/836,089, entitled “MULTIPLE FUNDING METHOD FOR HEALTH INSURANCE” filed Aug. 7, 2006, the entirety of which is incorporated by reference herein.

### BACKGROUND OF THE INVENTION

1. Field of the Invention

The present invention is directed to a method and system for providing multiple funding sources for healthcare and health insurance. Specifically, the present invention is directed to providing full-time, hourly, part-time, seasonal, and temporary employees and/or workers with multiple funding sources and means for access to health insurance and other qualified medical expenses.

2. Background of the Related Art

One problem that exists in the art today is that there are currently approximately 46 million people in the United States without health insurance, and the number of uninsured is rising. Many of these people are employed, having one or more part-time or temporary jobs, and/or perform seasonal work.

Currently, if a worker remains without health insurance for some period, and the worker and/or a covered family member has an existing health condition, the existing health condition may be considered as a pre-existing condition and the worker may likely be excluded from a new policy if the worker and/or family member moves to a new policy. This circumstance may leave workers and their families exposed to a lack of necessary medical care and potentially subject to financial ruin.

The present state of the art focuses on employer-provided health insurance policies. Workers who have employer-provided healthcare insurance may feel handcuffed to an existing job, especially if suffering from a chronic illness. For employers, providing healthcare coverage to employees is costly and time-consuming. To reduce costs by limiting access under the current paradigm, many employers require workers to work a minimum number of hours before qualifying for employer-provided healthcare coverage. If a worker's hours are under the minimum, the worker may not be able to participate in an employer-provided healthcare plan, nor may the worker typically gain any type of healthcare credit for the hours worked.

To further control costs, some employers create a waiting period, during which a worker will have to wait a period of time to qualify for employer-provided healthcare. For many workers, e.g., seasonal workers and workers who leave before or immediately after qualifying, this frequently poses a problem.

Furthermore, under the current system, most workers, with the exception of certain classes of union workers under the Labor Management Relations Act of 1947 (also known as the Taft-Hartley Act), do not earn hourly monetary credits that may be applied towards healthcare coverage, no matter how many or how few hours a person works.

Another problem existing in the art today is that many large employers are unfairly burdened with providing access to health insurance to spouses and family members of employees. Currently, no mechanism exists for multiple unconnected employers to make individual partial contributions to pay for a single family insurance policy. The present state of the art does not allow families that have multiple workers in a family unit to combine healthcare contributions from each employer into a family account.

Yet another problem existing in the art today is that employer-provided healthcare policies are not portable. As soon as an employee's employment is terminated, the employer typically ceases to contribute to healthcare insurance coverage.

Under specific circumstances, some former employees (and/or eligible family members) in this situation may be eligible for health insurance under the 1986 amendment to ERISA, also known as the Consolidated Omnibus Budget Reconciliation Act (“COBRA”). Under COBRA, however, the former employee (and/or eligible family member) pays the health insurance premiums, not the employer.

The present state of the art does not provide adequate wellness and preventive care services for the vast majority of workers and their families. At a small number of large companies or government agencies, some wellness services may be available. However, typically little to no wellness services are provided by small employers.

Presently, workers are not allowed to buy insurance using funds aggregated from multiple sources or to pool their buying power with other individuals to obtain discounts for healthcare, vision care, dental care, long-term care, or prescription drugs, unless obtained through an employer or association. Nor does the present system provide workers with their own insurance broker to act as their personal advocate over disputes of coverage or in negotiations of rates with providers.

Further, the present state of the art often limits an employee's ability to select healthcare options that are best suited to meet their lifestyle or living situation. Under the present paradigm, health carriers offer employers a select number of healthcare policies. If a worker would prefer to allocate employer funds in a different manner, they are trapped inside choices offered by the carrier to the employer.

Workers are generally not allowed to use employer contributions for deductibles, co-payments, uncovered prescription drugs, or eligible over-the-counter drugs. Exceptions to this general rule do exist, such as Flexible Savings Accounts (FSAs). The present state of art does not offer a mechanism for Federal, state, family or charitable contributions that can be used to supplement the purchase of individual portable policies of workers.

Many employers can only afford to devote a limited amount of funds to healthcare. Because of the problems in the current state of the art, these employers may choose to curtail workers' hours to avoid providing certain classes of workers with healthcare (e.g., where healthcare eligibility is based on hours worked). Even during periods of demand for more labor, employers may choose to restrict hours of workers because of the high costs of paying for full healthcare benefits. This can cause hardships for both employers and workers in attempting to manage hours.

Many insurance carriers require employers to enroll a minimum number of workers before providing coverage. Thus, for example, if an employer has less than the required number of workers enrolled, this may lead to increased expenses and/or creation of other roadblocks for employers and workers.

Because there are approximately 46 million uninsured Americans, Federal, state and municipal governments are forced to provide billions of dollars in expensive healthcare benefits. These government entities have been struggling for years to resolve this expensive and growing problem. It is reported that more than 23% of every employer and worker healthcare dollar goes to payment for uncompensated care and cost shifting from Medicaid and Medicare.

There is a need in the art for improved methods and systems for providing access to health insurance. There is a further need in the art for methods and systems for providing access to health insurance to workers who are employed in one or more part-time or temporary jobs, and/or who perform seasonal work. There is yet a further need in the art for methods and systems for providing access to health insurance while complying with the requirements of ERISA. There is yet a further need in the art to ease the financial burden on those employers who provide access to health insurance for spouses and family members of employees, especially when the spouses and/or family members may be employed in one or more full-time, part-time or temporary jobs, and/or perform seasonal work. There is yet a further need in the art to provide portable health insurance policies, which are owned by the insured (e.g., a full-time, part-time, temporary or seasonal employee, or an employee who has more than one employer), and which do not terminate each time the insured's employment is terminated or changes.

### SUMMARY OF THE INVENTION

Embodiments of the present invention solve one or more of the above identified needs, as well as others, via methods and systems for providing access to health insurance. In addition, embodiments of the present invention provide methods and systems for providing access to health insurance to workers who are employed full-time in one or more part-time or temporary jobs, who perform seasonal work, who move from job to job on a permanent basis (e.g., construction worker; software developer), or who are members of a family unit, in which more than one person works. Among other things, embodiments of the present invention allow healthcare contributions from more than one employer to be combined and applied towards payment for a healthcare insurance policy and other qualified medical expenses for the worker and/or the worker's family.

Other features and advantages will be apparent to persons of ordinary skill in the art from the following description of the invention and the accompanying drawings.

### BRIEF DESCRIPTION OF THE DRAWINGS

FIG. 1 illustrates an example of the open system architecture of the present invention, for use in accordance with embodiments of the present invention.

FIG. 2 shows an exemplary flowchart of an overview of the method for providing temporary, part-time, seasonal and full-time employees and workers with access to health insurance, in accordance with an embodiment of the present invention;

FIG. 3 shows an exemplary flowchart of financial administration functions, performed in accordance with one embodiment of the present invention;

FIG. 4 shows an exemplary flowchart of insurance administration functions performed in accordance with one embodiment of the present invention;

FIG. 5 shows an exemplary flowchart of processing of premium collection and distribution functions, performed in accordance with one embodiment of the present invention;

FIG. 6 presents an exemplary system diagram of various hardware components and other features, for use in accordance with an embodiment of the present invention;

FIG. 7 is a block diagram of various exemplary system components, in accordance with an embodiment of the present invention;

FIGS. 8A-8E show exemplary Graphic User Interface (GUI) screens of various aspects of the method and system for providing access to health insurance, in accordance with an embodiment of the present invention;

FIG. 9 shows an exemplary File Record Layout (FRL) file layout for upload from an employer to a Financial Administrator, in accordance with an embodiment of the present invention;

FIG. 10 shows an exemplary schematic depicting various entities relating to the functionality of an embodiment of the present invention, and the interfaces and connections among them;

FIG. 11 shows an exemplary GUI interface screen for an exemplary insurance policy holder, in accordance with an embodiment of the present invention; and

FIG. 12 shows an exemplary method for an employee-facilitated selection, sale and issuance of an insurance policy.

### DETAILED DESCRIPTION

The present invention contains features that address the following areas, among others: 1) ownership of the health insurance policy; 2) refined defined contribution; 3) meeting the needs of all workers (e.g., whether employed full or part-time, or on a seasonal basis); 4) refined utilization of Federal Health Reimbursement Accounts (HRAs); 5) portability of the health insurance policy; 6) coordination of funds from multiple employers for an individual or family; 7) additional policy options; 8) options to cover additional types of healthcare costs; 9) government subsidies; 10) private subsidies; 11) worker wellness and advocacy; 12) benefits to employers; 13) benefits to Federal, state, and municipal governments; 14) and a specialized financial and insurance processing tracking and reporting system.

These features will now be described in conjunction with example embodiments of methods and systems of the present invention.

Ownership

The present state of the art generally features an employer-sponsored (selected and managed) health insurance policy and employer-directed or allowed healthcare spending. The present invention focuses the control of health insurance and healthcare spending on the worker and/or the worker's family unit.

In accordance with the present invention, the employer does not design, choose, purchase, manage or own employees' health insurance policies.

In accordance with the present invention, the worker designs, selects, purchases, manages and owns the health insurance policy.

Each employee may select and purchase an individual/family health insurance policy from any health insurer offered by a qualified broker as allowed by state law.

Each employee is responsible for selecting and managing managing the employee's own health insurance policy.

Refined Defined Contribution

Embodiments of the present invention provide workers and employers with new methods and systems for coordinating contributions for healthcare.

Embodiments of the present invention allow an employer to make a defined contribution for healthcare for every hour worked by a worker. A worker does not have to work a minimum number of hours to qualify for payment for healthcare. One hour of work can earn a worker one hour's worth of healthcare contribution by the employer.

The employer sets the contribution amount, unless superseded by State and/or Federal law. The employers' healthcare contributions are deductible for tax purposes by the employer and are not includible in the employee's gross income.

Money contributed by an employer is received, processed, held, and disbursed for each worker using a HRA or other similar instrument.

Embodiments of the present invention do not require any employer to contribute to healthcare for workers, if the employer does not choose to do so. However, if an employer chooses to contribute to a worker's healthcare, the worker must receive a contribution that is the same for each individual or family member, according to ERISA and the Internal Revenue Code requirements. The employer decides the amount to be contributed.

Generally, there are no limits on the number of employers that may contribute to an individual employee's healthcare via HRAs.

Each contribution of the healthcare contributors for a HRA may be calculated, for example, on the basis of the employee's work hours, monthly salary, or based on another negotiated mechanism.

Meeting Needs of Old and New Economy Workers

The methods and systems of the present invention, in one exemplary embodiment, permit single or multiple contributors (e.g., employers, charitable contributors, state and/or federal subsidies) to contribute to the cost of an employee's healthcare policy.

Under the present invention, if a worker has three different employers, each employer can contribute towards the worker's healthcare by means of a defined dollar contribution per hour worked. If a worker works full-time for one employer and has a part-time employer on the weekend, each employer can contribute (e.g., on an hourly basis). If a worker moves seasonally among employers, each employer can contribute (e.g., on an hourly basis). If a worker works temporary jobs, and moves from employer to employer and state to state, each employer can contribute (e.g., on an hourly basis). If a family unit has a father who has four part-time jobs, a mother with one full-time job, and three kids, two of whom work in different fast food restaurants, each of the various employers can make healthcare contributions to the family member who works for them and the system of the present invention can pool these funds to purchase a single health insurance policy for the family and to cover additional qualified medical expenses.

If two workers are married and each has a full-time job with different employers, each employer can contribute to each worker's healthcare via a HRA. The couple can combine the funds to purchase their own individual family policy.

If a worker with a chronic disease has acquired a health insurance policy (either as an individual or part of a family) and is laid off, the funds contributed to the worker via a HRA in accordance with an embodiment of the present invention, allow accumulated funds in the HRA to be used to maintain the worker's individual or family policy with no interruption in coverage, as long as premiums continue to be paid.

In one embodiment, the present invention allows an employee to engage in concurrent or serial employment, while maintaining a health insurance policy, regardless of which employer is currently providing employment.

Refined Utilization of Federal HRAs

In embodiments of the present invention, methods and systems for providing worker-owned health insurance utilizing employer funds contributed to a HRA.

The invention accepts funding from any employer enrolled in the process for all types of workers (e.g., full-time, part-time, temporary and/or seasonal or serial employer) and places the contributed funds in a Health Reimbursement Arrangement (HRA) for the employed individual.

Each employer healthcare contributor, with assistance from a financial administrator or other assistant/entity, creates a HRA account for the employer in a recognized financial institution. The HRAs will be treated as ERISA plans. Monies deposited into the account will be segregated and held in trust for each employee of the employer. A worker can have more than one HRA account with money available to the worker (e.g., since a worker can have more than one job or because funds from a previous employer's HRA have not yet been depleted and the worker has started an additional HRA with a new employer).

Each employer's financial contributions must comply with ERISA and other nondiscrimination rules (e.g., the same amount must be provided to each employee within a permitted class of employees on a non-discriminatory basis). An employer can differentiate between individuals and family members as to amount of reimbursement.

The dedicated funds are held in trust in a bank on behalf of the employee. Thus, the employee will not be prejudiced if an employer goes out of business.

Each employee's qualified healthcare expenses are reimbursed from the HRA(s). Even upon cessation of employment with a particular employer or employers, the employee may continue to draw on funds left in that or those HRAs. This helps to ensure no gap in coverage develops and that the policy remains in force.

If funds contributed by one or more employers of a worker or worker family unit are not completely exhausted, the funds are carried over, such as year after year, for the use by the worker and the worker's qualified dependents. The funds are carried over even if the worker or any worker in a family unit leaves the employ of any of the employers.

The funds in the employee's HRA(s) may be less than or greater than the amounts needed to pay the premiums for the chosen health insurance policy.

If the funds are less than the amount needed, the employee (or another person or entity, such as the state) may contribute funds outside the HRA to make up the difference. If the funds are greater than the amount needed, the excess funds accumulate in the HRA account(s) until used to pay health insurance premiums or other qualified medical expenses.

Upon depletion of all HRA funds, the employee and/or other contributor(s) may continue to make health insurance premium payments.

In addition, optionally if the policy becomes inactive for a specified period of time (e.g., 3 years), the funds may be returned to the plan assets and allocated among other HRA accounts then being funded by the employer.

Funds earned for healthcare from an employer maintained in a HRA can only be utilized for health insurance premiums and other qualified healthcare expenses. Unlike other types of funding mechanisms, such as a Health Savings Account (HSA), funds cannot be taken out of a HRA for use for non-healthcare expenses.

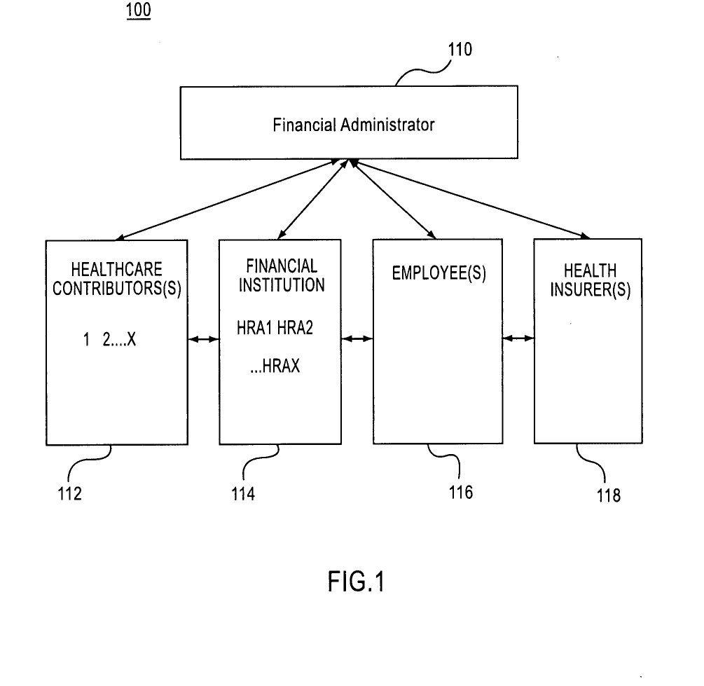

Referring now to FIG. 1, therein shown is an example of an open system architecture, for use in accordance with an embodiment of the present invention. Each healthcare contributor 112, such as an employer, with assistance from a financial administrator or other assistant/entity 110, creates ERISA-compliant HRA accounts, held in trust for one or more employees, at a recognized financial institution 114. There are no limits of the number of employers of a given employee who can each establish, and contribute to, a HRA for their common employee. Additionally, there are no limits on the number of other contributors who can make healthcare payments on behalf of the employee outside the employer-sponsored HRA(s) 114. Employers of family members may contribute to HRA(s) established for those family members. And other contributors may also make healthcare contributions on behalf of the respective family members outside the family member HRAs. Each contribution by the employer healthcare contributors 112 to the HRA(s) 114 may be calculated, for example, on the basis of the employee's work hours, or based on another negotiated mechanism, with the assistance of the financial administrator or other assistant/entity 110. There is no preset basis for determining the contributions made outside of the employer-funded HRA(s).

Each employee 116 may select and purchase an individual/family health insurance policy from any health insurer 118 and/or pay for other qualified medical expenses. Each employee 116 is reimbursed, or a premium is paid directly from the HRA(s) 114. Upon cessation of employment, the employee 116 may continue to draw on the HRA(s) 114 to ensure that no gap in coverage develops and that the policy remains in force. Upon depletion of the HRA 114 funds, the employee and/or other contributor may continue to make health insurance premium payments.

Portability

The present invention provides for portable health insurance policies owned by the insured worker, which will not terminate each time the insured's employment is terminated.

Under the present invention, if a worker leaves the employ of an employer, the policy follows the worker. The policies are totally portable under embodiments of the present invention since the worker owns the policy—not the employer. This is true even if the worker or a covered family member has a pre-existing healthcare condition. Among other things, the present invention frees workers from the handcuffs of employer-based healthcare and provides personal choice and work freedom. The health insurance policy is portable and moves with the employee, for example, as long as the policy is maintained.

Family Coordination

Under the current state of the art, only one employer typically makes healthcare contributions or offers health insurance benefits, no matter how many employers a worker has or how many workers in a family unit are employed. Further, under the current system, even if each spouse has health coverage, the resulting “coordination of benefits” only allows for procuring two full health insurance policies (e.g., two individual policies or one individual policy and one family policy), not a single family policy. The result is often redundant coverage for certain members of the family and/or other anomalies.

The present invention allows contributions from every employer of a worker and every employer of all workers in a family to be utilized to pay for the health insurance coverage and other qualified medical expenses for the worker or the family unit.

Under embodiments of the present invention and in compliance with current Federal law, the funds from each and all employers of every worker follow the worker to be used for qualified medical expenses, whether the worker continues to work for the employer or not. For example, if a worker belongs to a family unit, the various employer funds from each worker in the family unit would be held in trust and coordinated to pay for health insurance premiums or other qualified medical expenses on a family basis.

Embodiments of the present invention permit aggregation of employer contributions for each family member, to allow employer's funds from HRA contributions to be used for the family's health insurance policy and/or other qualified medical expenses of family members.

Additional Policy Options

Under the present system, employers limit the types of policies that can be offered to workers. According to the present invention, workers and family members can choose from a wide variety of policies to best match the insurance coverage to their life situation.

For example, a single 22 year old male does not need the same type of policy as a young family of four or as a semi-retired 66 year-old who still works 25 hours a week.

Options to Cover Additional Types of Healthcare Costs

Among other things, the present invention allows workers greater flexibility with employer funds earned by the worker and contributed for healthcare. Under a traditional employer-based healthcare system, an employer selects, pays for, and administers a group health insurance policy for qualified employees. Vision and/or dental plans may or may not be included. Flexible Spending Accounts (FSAs) may or may not be offered. Even if an FSA is offered, the FSA funds must be spent by the end of the year, creating a disincentive to save money and/or an incentive to utilize healthcare resources, even if they are not needed.

Under embodiments of the present invention and in compliance with Federal laws and regulations governing HRA plans, employer funds earned by the worker may be used by the worker for a healthcare insurance premium, dental care insurance premium, vision care insurance premium, long-term care insurance premium, to pay a deductible, to make a co-payment, to pay for uncovered prescription drugs, and to pay for qualified over-the-counter medical items, and other qualified medical expenses.

Government Subsidies

More state and local governments are realizing the importance of providing subsidies to low-income individuals and families for healthcare. The cost of individuals with no healthcare to state and federal governments is growing every year. People with no insurance rarely are able to obtain preventive care. When these uninsured individuals show up at a hospital or other health services provider, the provider often is faced with treating an acute illness that many times could have been easily and cheaply prevented, if only the person had healthcare coverage.

A deficiency exists in healthcare coverage. Employees that have income under a certain predetermined amount may be eligible for Medicaid, Medicare, or another type of assistance. But as statistics show, more than 62% of the over 45 million people who are uninsured are working and do not receive healthcare benefits from their employer nor qualify for government assistance.

Under the method and system of the present invention, healthcare benefits may be provided to millions of these people.

The state subsidy systems established to cover low income workers typically are not structured to assist workers with multiple, serial, seasonal, temporary jobs or who are part of a family unit where more than one person works. Current state subsidies, if incorporated with one or more of the methods and systems of the present invention, may assist in efficiently providing coverage to the under- or uninsured.

According to one embodiment of the present invention, workers (e.g., single, part of a couple, or part of a family unit) who qualify for existing or new government subsidies may be pre-qualified for their privately owned healthcare insurance policies, prescription drug coverage, deductibles, and/or co-pays. Further, these workers may be enrolled in the respective subsidy program, and a computerized interface may be provided to the government agency that will be accessed if a worker qualifies for a subsidy. The present invention, in one embodiment, provides governments with disclosure and an auditable trail to assure public funds are utilized as required by applicable law.

Private Subsidies

The present invention can also facilitate workers' acceptance of financial contributions from charities, relatives, or friends, which may be used for payment of qualified medical expenses.

Embodiments of the present invention will identify non-governmental sources for subsidies. An interface may be created with these financial sources, and the sources may be notified of potential shortfalls in premiums or needs to pay other healthcare expenses. According to some embodiments of the present invention, voluntary contributions from such sources will be processed, and the monies directed to the worker-selected cost item. According to one embodiment, the voluntary sources may be notified to ensure contributions are received and processed before any lapse in coverage takes place.

Worker Wellness and Advocacy

Embodiments of the present invention will bring a new level of service to workers.

Presently, workers who are enrolled in a group employer policy have little to no advocacy access to address perceived employee problems with the employer's group health plan. Brokerages, who handle the policy for the employer, see the employer, not the worker, as the client.

In one embodiment, the present invention works as an advocate for worker members in negotiating discounts and resolving coverage disputes with health insurance carriers or other health service providers. Embodiments of the present invention work as an advocate for worker-members in all aspects of healthcare coverage provided to the worker-member.

In another embodiment, the present invention may provide professional wellness services, pre-screening services, and preventive care services to eligible members, with or without the assistance of trade associations, unions, professional associations, or other organizations. These types of organizations often have a close relationship, for example, with the worker and offer a path to provide information and develop a relationship to improve healthcare for the worker and/or worker's family unit.

Benefits to Employers

As a result of the invention and the transfer of healthcare responsibility from the employer to the worker, among other things, employers save some of the expenses related to management of health insurance to employees, such as expenses associated with employing benefits coordinators, human resources personnel, and insurance consultants.

In one embodiment, employers decide on an appropriate contribution level and funds transfer (e.g., from the employer bank account to employer HRA account on each pay period).

According to one embodiment of the present invention, the employer provides healthcare contributions to workers, e.g., based on hours worked. For example, if the worker works one hour, one hour of healthcare contribution is required. Twenty hours, 30 hours, 40 hours or more only require the employer to contribute for the hours worked. This enables the employer to have greater flexibility in offering workers more hours.

Many employers have not been able to offer healthcare benefits to their workers because of the cost of group insurance plans. These employers have seen qualified workers leave their employ, due, for example, to the lack of healthcare benefits. These employers desire a method to offer some type of healthcare benefit contribution. Embodiments of the present invention enable employers to contribute to their workers' healthcare in a more flexible manner, and to offer some type of contribution for healthcare to all of their workers, with a contribution amount that can change based on an employer's ability to pay.

Benefits to Federal, State and Municipal Governments

Over 62% of the approximately 46 million uninsured in the United States have jobs. The American Hospital Association recently reported that community hospitals provided $28.8 billion in uncompensated care in 2005.

Meanwhile, Medicare and Medicaid shortfalls at community hospitals in 2005 increased by 14.5% to $25.3 billion, from $22.1 billion in 2004.

Embodiments of the present invention can help place millions of workers, who are not employed in a full-time job with health benefits, on a more equal footing with other types of workers. Families who have several working family members, individuals with multiple part-time jobs, workers moving from employment to another, and many others will now have an opportunity to obtain healthcare benefits that may equal or exceed the benefits received by their full-time counterparts.

By providing a method to facilitate employment-based healthcare contributions, our invention helps previously uninsured workers gain access to a family doctor, and their children/families can obtain vaccinations and preventive care. The funds may be used for, among other things, screening for high blood pressure, diabetes, hypertension, and pre-natal care. In addition, government cost-shifting of uncompensated care costs to employers and workers may be significantly reduced.

Specialized Financial and Insurance Processing Tracking and Reporting System

To facilitate this type of new personalized healthcare paradigm, embodiments of the present invention provide a specialized process to collect worker information and employer funds earned by workers for healthcare in an efficient and low-cost manner, and to hold the money in trust for the worker.

According to one embodiment, information is collected on each employee or worker and each family member that works. A database is created of all employers employing an individual or various members of a family. Each of these employers is then contacted, e.g., via a financial administrator or other entity, to arrange for healthcare contributions for each worker, in compliance with applicable federal and state laws. According to one embodiment, the employer data is entered into a computerized system. An employee completes a policy application form (e.g., online or paper copy), including information regarding each employer of the applicant and each employer of any family member of the applicant. Additional information included in the application form may include whether the applicant qualifies for financial assistance from another entity, such as government, charitable organizations and/or relatives or friends.

When an employer registers to contribute employee/worker healthcare funds via a HRA, the method and system of some embodiments of the present invention collect information, e.g., on a pre-arranged time period basis, data of hours worked and/or other method of agreed upon reimbursement, for each employee/worker. Using the data, in one embodiment, the present invention determines the amount of healthcare funds the employer has agreed to provide for each worker, as well as the total amount owed by the employer for healthcare-related reimbursements. In one embodiment, the system of the present invention accesses the employer's account, retrieves the funds, and holds the funds in trust in a financial institution, e.g., a Federally chartered bank, for the worker's use of the funds for qualified medical expenses.

When the worker provides the proper documentation for qualified medical expenses, the software system will process the documentations and extract the funds from one or more HRAs for the worker. The invention, utilizing the invention process, can extract funds from one or more HRAs for each worker.

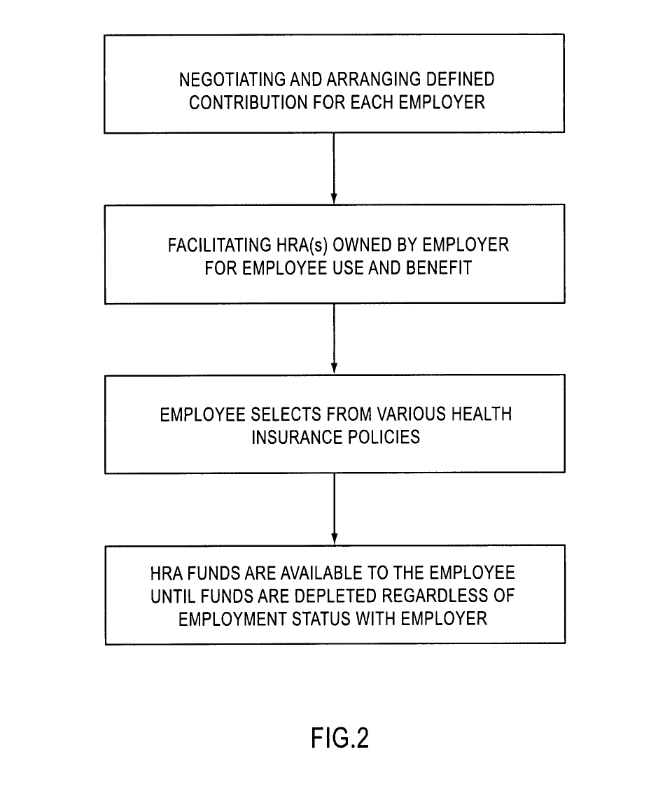

Referring now to FIG. 2, therein shown is an exemplary flowchart of an overview of the method for providing temporary, part-time, seasonal and full-time employees and workers, for example, with access to health insurance, in accordance with an embodiment of the present invention. A defined healthcare contribution is negotiated with each employer 210. HRA accounts are created 220. Eligible employees may select from various health insurance policies 230. The HRA funds may be used by the employee to cover health insurance premiums, and for other qualified medical expenses regardless of whether the employee changes employers.

If the employee is part of a family unit, in which more than one family member works, the method and system of the present invention, in one embodiment, conduct an analysis of the HRA funds. In one embodiment, the HRAs that were created first are utilized first. For example, if a worker has funds left in a HRA from a previous employer, those funds will be utilized prior to funds available from newer HRAs from more recent employers.

If more than one person in a family unit works and has HRA(s) available for reimbursement, funds from the multiple HRAs may be combined based on various factors including, among others:
the potential term of the employment (e.g., permanent, short-term, seasonal);
the amount of money allocated for healthcare for each worker (e.g., more funds may be drawn from accounts with higher contribution levels);
the price of a primary healthcare policy; and
the preferences of the worker member.

In one embodiment, the worker may be provided with a statement (e.g., monthly) reflecting the status of funds held in trust for that worker or family unit. The statement may also include information on healthcare costs covered from the worker's HRA, covered by a governmental subsidy (if any), and/or covered by another entity. The statement may also show projected incoming healthcare reimbursement monies and expected healthcare costs.

With this information, workers and family units can make better decisions about how much money to spend on healthcare. Workers can decide how, if they reduce spending for healthcare, the worker or family unit can save funds for use on other qualified medical expenses besides health insurance premiums, such as vision care, dental care, long-term care, deductibles, non-covered prescription costs, and/or over-the-counter health items.

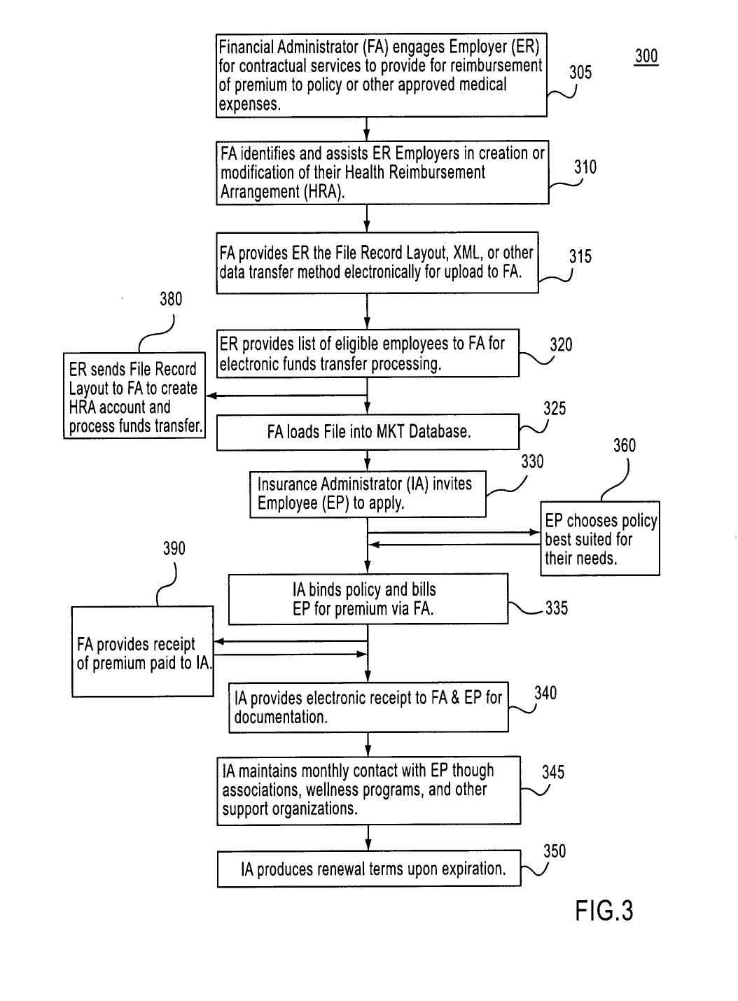

Referring now to FIG. 3, therein shown is an exemplary flowchart 300 of financial administration functions performed in accordance with one embodiment of the present invention. For example, a Financial Administrator (FA) may manage the health reimbursement arrangement for all employers who agree to participate in the program. In one embodiment, the FA maintains all bank contracts, the Automated Clearing House (ACH) contracts or other Electronic Funds Transfer (EFT) agreements with banks, and all data processing. The FA transmits the files and the monies to be collected from payers and to be remitted to insurance carriers. The FA also performs reporting functions as required by IRS and ERISA rules for the employer and other payers.

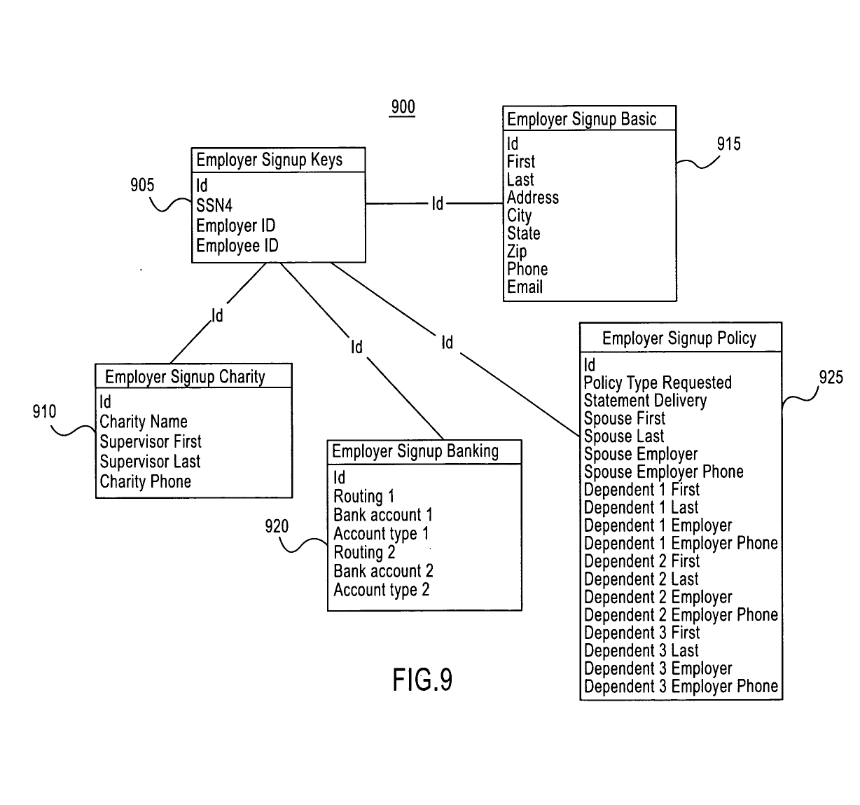

In accordance with one embodiment, a Financial Administrator (FA) engages an employer for contractual services to provide reimbursement of qualified medical expenses through use of an HRA 305. The FA provides employers with the FA File Record Layout (FRL) for upload to the FA 315. The FRL may be, for example, electronic record layout, such as a Microsoft® Excel spreadsheet (XLS) file or Comma Separated Value(s) (CSV) file, which the employer completes to include information regarding the names of the individual employees, their contact information, the amount each employee will be provided on a periodic basis for the employees' HRAs, and other information. The FRL file is described in more detail below in reference to FIG. 9.

When the employer identifies the list of eligible employees for financial processing 320, the file is transmitted to the FA for processing (see transmission 380 of FIG. 3). The FA receives the funds from the employer.

Referring again to FIG. 3, the funds transfer is processed and a HRA is created for each eligible employee 380. The funds are transmitted to a Financial Administrator (FI).

After processing the funds transfer and creating the HRA 380, the FA loads the employee file into a marketing database 325. At that point, the FA provides the eligible list of employees to an Insurance Administrator (IA) who invites the employee(s) to apply for healthcare insurance coverage 330. Employees can apply for healthcare policies, for example, online, via a call center, or via a paper application. Each employee selects the policy that best meets their needs 360. The IA or the insurance carrier binds the policy and bills the employer for the premium via the FA 335 (see transmission 390). The FA transmits the funds to the carrier.

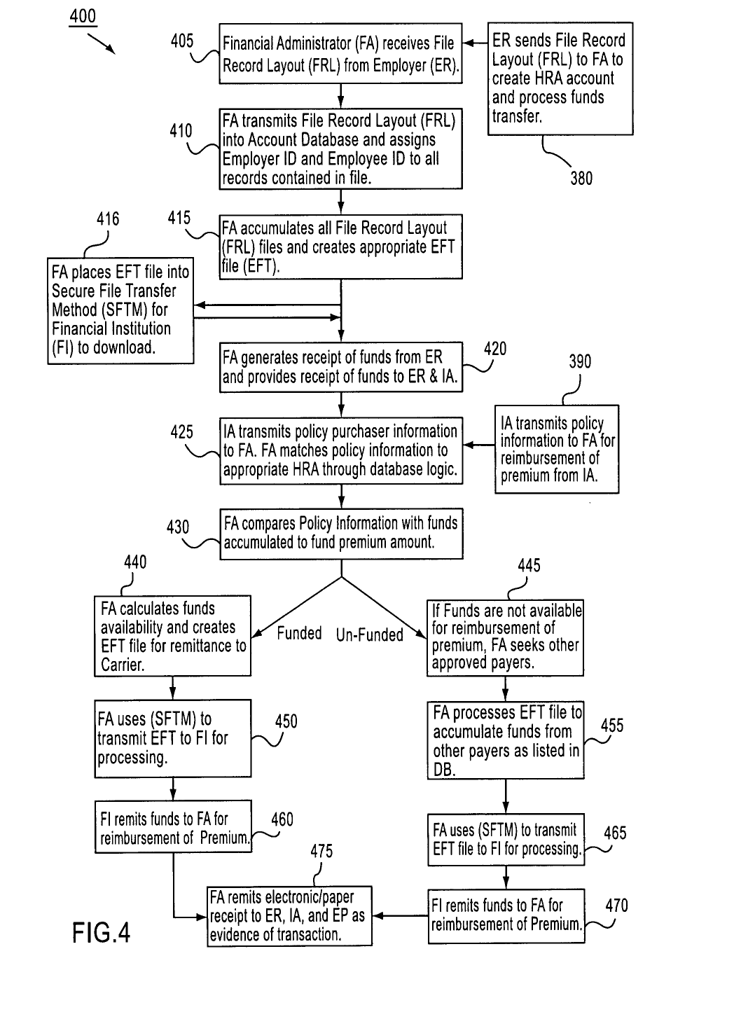

Referring now to FIG.4, the FA provides receipt of premium paid to ER 475. At this point, referring now to FIG. 3, the IA provides a receipt (e.g., electronic) to the FA and the employee for documentation and the funds are withdrawn from the HRA for the employee 340.

In one embodiment, the FA also maintains periodic (e.g., quarterly, monthly, weekly) contact with the employer through associations, wellness programs and other support organizations 345. In addition, in one embodiment, the IA produces renewal terms upon expiration of the policies, typically on an annual basis 350.

Referring now to FIG.4, therein shown is an exemplary flowchart 400 of insurance administration functions, in accordance with one embodiment of the present invention. The insurance administration functions may be performed by, for example, any licensed insurance broker or agent.

A File Record Layout (FRL) is transmitted to create a HRA account and process funds transfer 480. The FA receives the FRL 405. In one embodiment, the FRL contains information including employer identification (ID), employee ID, and the dollar amount that the employer is contributing to the employee's HRA. The FA transmits the FRL for storage in an account database or other repository of data, and assigns the employer and employee IDs to all records in the file 410. The FA accumulates all FRLs and creates corresponding EFT files 415. Upon creation of the EFT file, this file is securely transmitted, e.g., via a Secure File Transfer Method (SFTM) to a financial institution (FI), such as a bank (interchangeably referred to herein as a banking administrator), for download and transacting with the Federal Reserve Bank to move the funds 416. The funds are received from the FI, the FA generates receipt of funds from the employer, and provides receipt of funds to the IA and/or the employer 420. The IA transmits the employee's policy information to the FA 425.

The FA compares the policy information with the funds accumulated to fund the premium amount (e.g., the policy premium amount due in the given month is compared with the accumulated health reimbursement arrangements associated with the individual and other family members, if appropriate) 430. The accumulated funds include, for example, all employer funds that were contributed towards the individual's healthcare (and to family members' healthcare) for the current period plus any excess funds not spent in prior periods. If the amount of accumulated HRA funds equal or exceed the minimum policy premium cost for the given month, the FA calculates the funds available and creates, for example, an EFT file for remittance of the funds to the insurance carrier 440. The FA transmits the EFT file to the FI for processing 450. The transmission may be performed via a SFTM.

The funds for payment of the premium are transferred to the carrier by the FI 460.

If the accumulated funds (e.g., in all available HRAs) are not sufficient to cover the premium, the FA seeks funds from other approved payers to cover the difference 445. Other approved payers may include, for example, post-tax funds from the employee, from relatives of the employee (e.g., parents, aunts, uncles), state agencies, charities, federal agencies and/or anyone who agrees to pay the required funds.

The FA performs processing (e.g., via an EFT file) to accumulate funds from other payers 455. The EFT file is transmitted for processing to, for example, a FI 465. The FI remits the funds to FA for reimbursement of the premium 470. The FA generates and transmits receipt(s) to the IA, the employer, the employee and/or other contributing parties as evidence of the transaction 475.

Any excess funds in the HRA(s) remain in a trust account with a recognized financial institution, under FA management under the terms of the HRA contract.

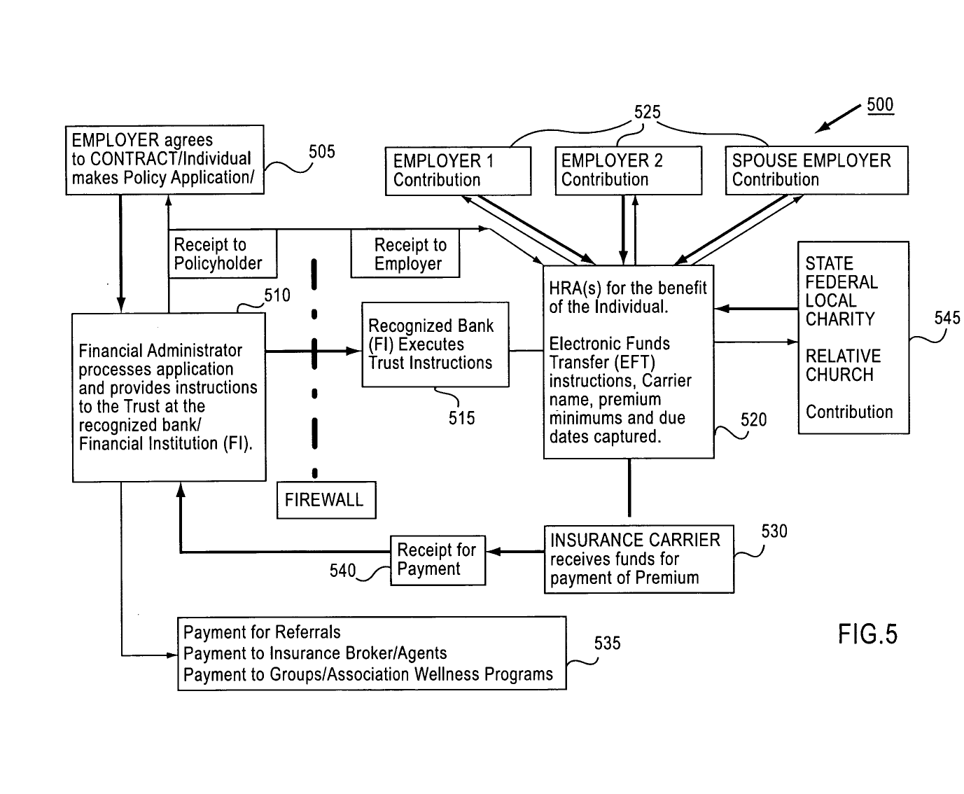

Referring now to FIG. 5, therein shown is an exemplary flowchart 500 of functions for processing of premium collection and distribution, in accordance with embodiment of the present invention. In one embodiment, an individual employee makes a policy application and an employer agrees to enter into a HRA contract 505. The individual employee can make a policy application first and the employer may agree to a HRA contract subsequently, or vice versa. In one embodiment, the two occur simultaneously, or almost simultaneously. Once the employer executes the HRA contract, the insurance and financial administration functions described in reference to FIGS. 3 and 4, are triggered to move funds for payment processing 510. Those funds may be moved to a recognized financial institution and held in a trust account 515. Once that occurs, the individual employee may select and purchase a healthcare policy. The employee may, e.g., with the assistance of a broker, complete an application online, by telephone, or by completing a paper application, which is then submitted to the insurance carrier.

Once confirmation is received that the policy is bound (i.e., the insurance carrier has approved the application and established a policy), the premium is paid out of the HRA, as detailed previously in reference to FIGS. 3 and 4. As shown on a macro scale in FIG. 5, the present invention is capable of receiving funds 520, from several employers, spouse employers, or any other payer 525, into the HRA account. Funds may be remitted to the insurance carrier, and receipts of payment may be transmitted to the policy holder, the employer or any other payer 520. Payers 525 may also include, for example, a charitable organization, or a state or federal agency.

The insurance carrier provides receipt for payment received to the broker 540. The broker makes payments for referrals and commissions (e.g., to insurance brokers or agents). The FA may make payments to groups and associations for additional wellness programs 535.

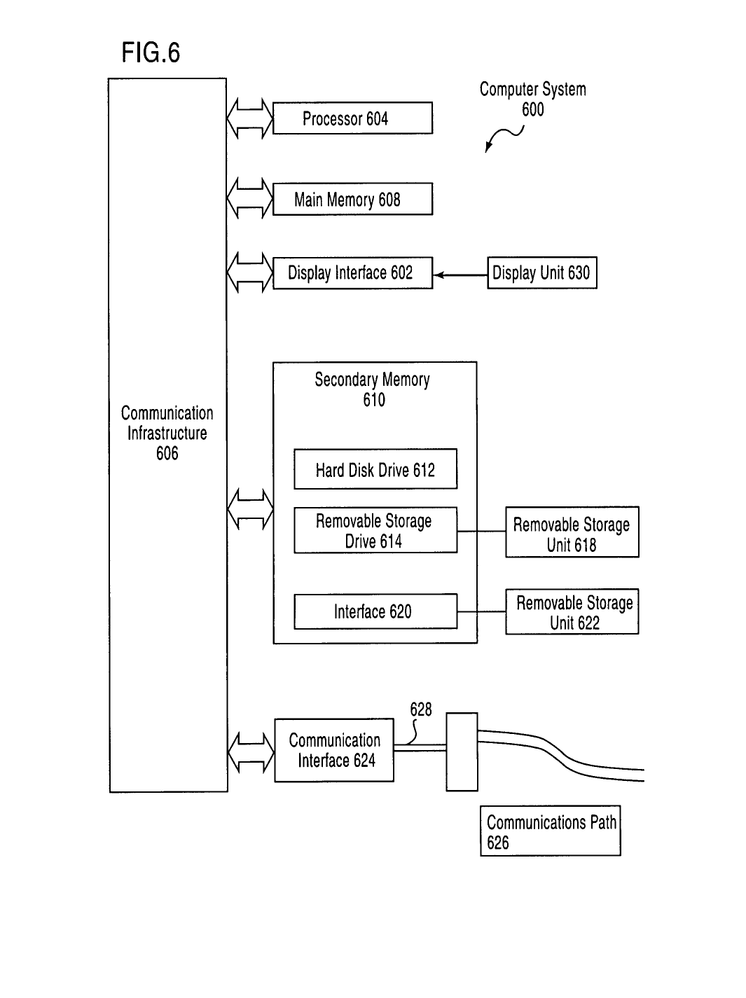

The present invention may be implemented using hardware, software, or a combination thereof and may be implemented in one or more computer systems or other processing systems. In one embodiment, the invention is directed toward one or more computer systems capable of carrying out the functionality described herein. An example of such a computer system 600 is shown in FIG. 6.

Computer system 600 includes one or more processors, such as processor 604. The processor 604 is connected to a communication infrastructure 606 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 600 can include a display interface 602 that forwards graphics, text, and other data from the communication infrastructure 606 (or from a frame buffer not shown) for display on a display unit 630. Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well-known manner. Removable storage unit 618, represents a floppy disk, magnetic tape, optical disk, etc., which is read by and written to removable storage drive 614. As will be appreciated, the removable storage unit 618 includes a computer usable storage medium having stored therein computer software and/or data.

In alternative embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628, which may be electronic, electromagnetic, optical or other signals capable of being received by communications interface 624. These signals 628 are provided to communications interface 624 via a communications path (e.g., channel) 626. This path 626 carries signals 628 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 680, a hard disk installed in hard disk drive 670, and signals 628. These computer program products provide software to the computer system 600. The invention is directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features of the present invention, as discussed herein. In particular, the computer programs, when executed, enable the processor 610 to perform the features of the present invention. Accordingly, such computer programs represent controllers of the computer system 600.

In an embodiment where the invention is implemented using software, the software may be stored in a computer program product and loaded into computer system 600 using removable storage drive 614, hard drive 612, or communications interface 620. The control logic (software), when executed by the processor 604, causes the processor 604 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

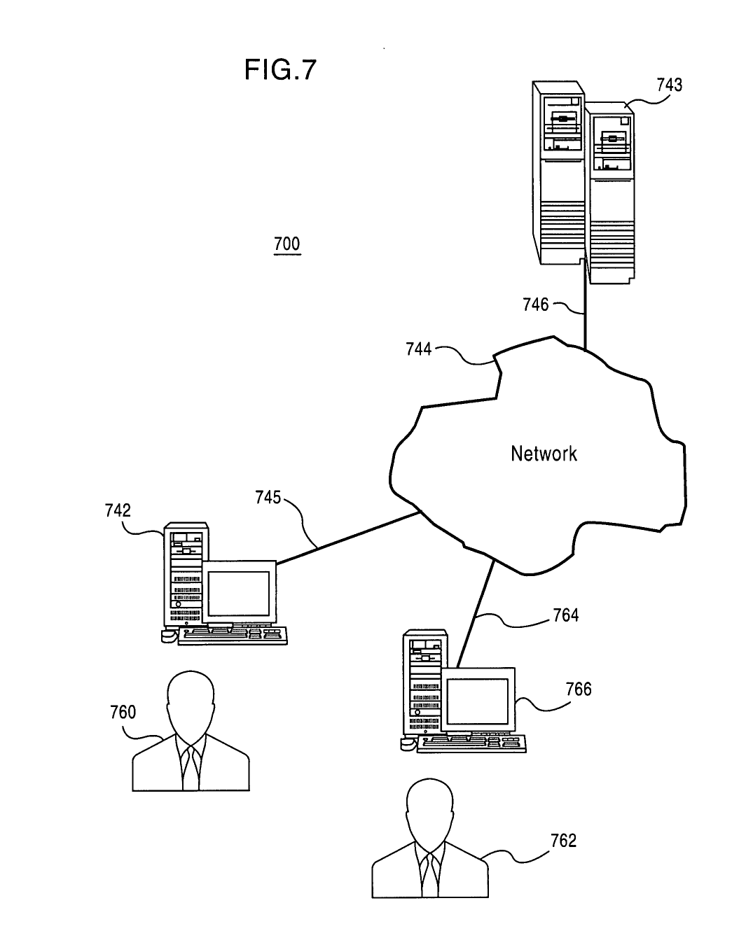

FIG. 7 shows a communication system 700 usable in accordance with the present invention. The communication system 700 includes one or more accessors 760, 762 (also referred to interchangeably herein as one or more “users”) and one or more terminals 742, 766. In one embodiment, data for use in accordance with the present invention is, for example, input and/or accessed by accessors 760, 764 via terminals 742, 766, such as personal computers (PCs), minicomputers, mainframe computers, microcomputers, telephonic devices, or wireless devices, such as personal digital assistants (“PDAs”) or a hand-held wireless devices coupled to a server 743, such as a PC, minicomputer, mainframe computer, microcomputer, or other device having a processor and a repository for data and/or connection to a repository for data, via, for example, a network 744, such as the Internet or an intranet, and couplings 745, 746, 764. The couplings 745, 746, 764 include, for example, wired, wireless, or fiberoptic links. In another embodiment, the method and system of the present invention operate in a stand-alone environment, such as on a single terminal.

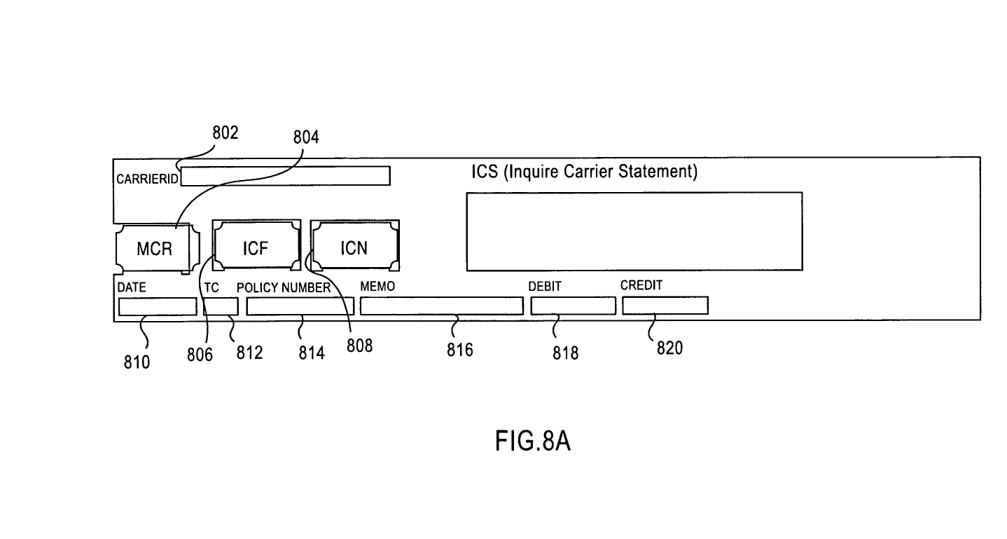

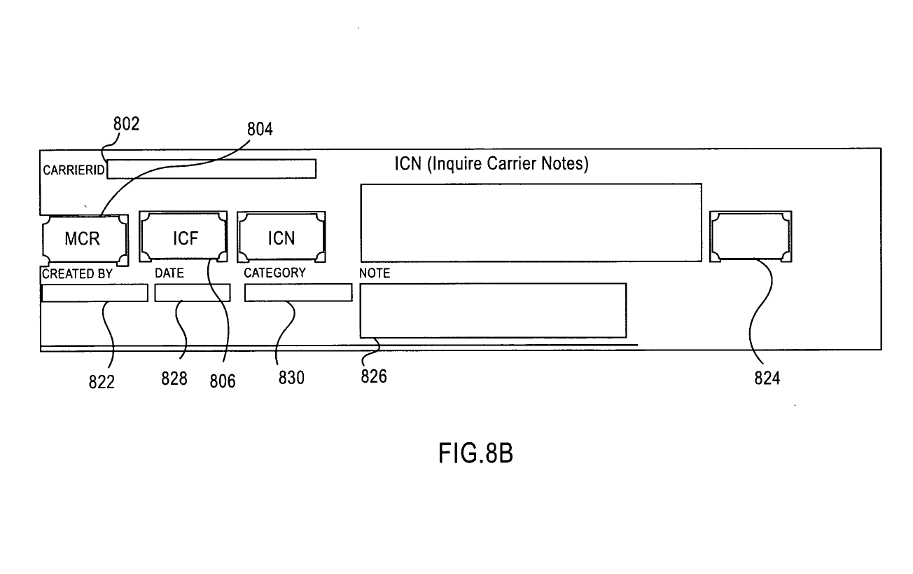

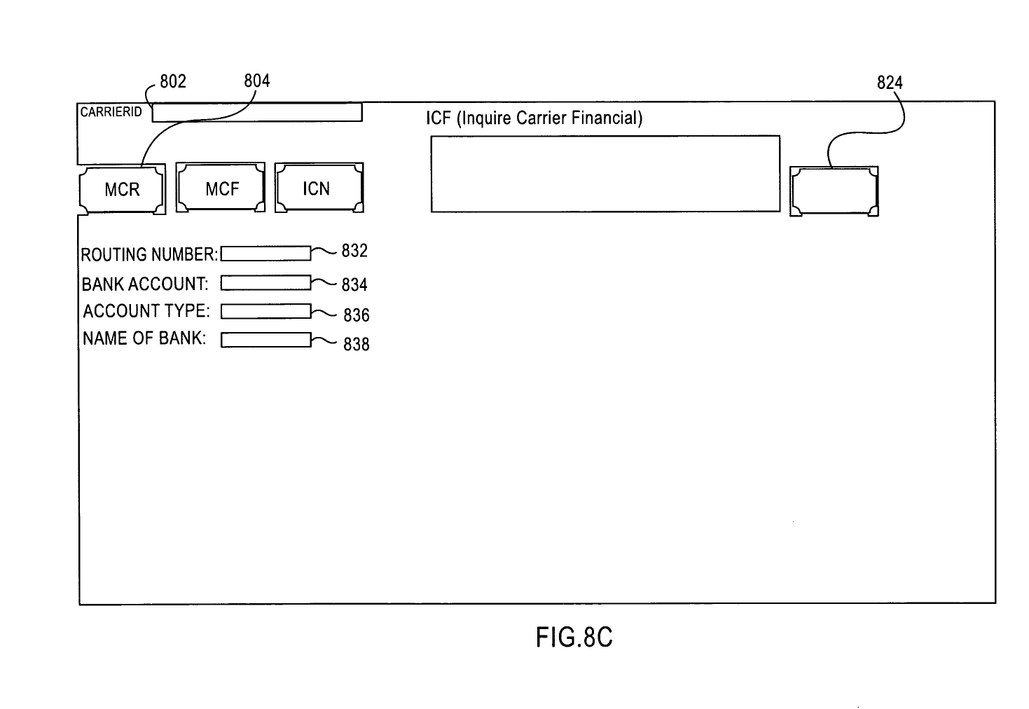

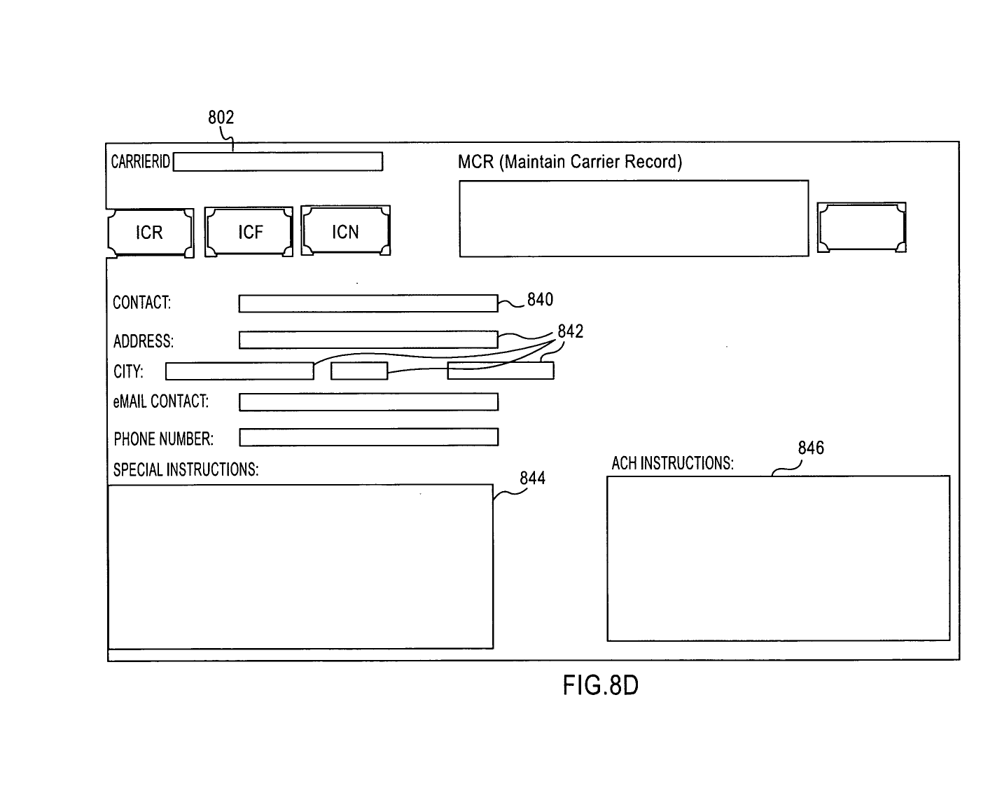

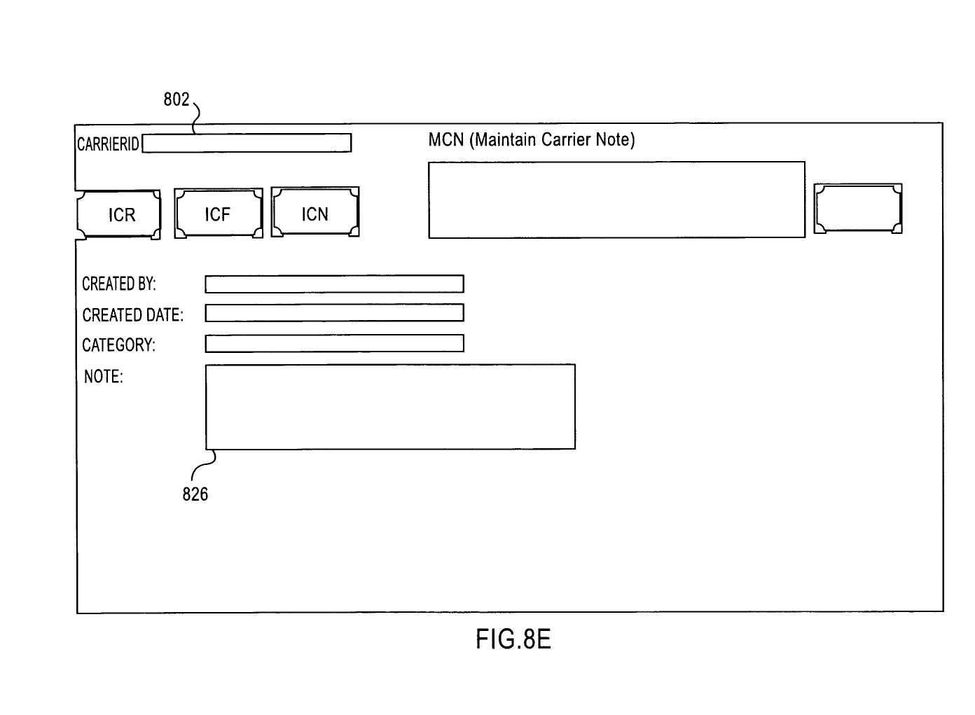

Referring now to FIGS. 8A-8I, therein shown are exemplary GUI screens of various aspects of the method and system for providing access to health insurance, in accordance with an embodiment of the present invention. The exemplary GUI screen Inquire Carrier Statement (ICS) screen, shown in FIG. 8A, shows carrier identification (ID) field 802, as well as fields for date 810, transaction code 812, memo 816, debit 818 and credit 820. Each partner carrier is assigned a carrier ID, which is shown in field 802. The ICS GUI screen also contains links to the Managed Carrier Record (MCR) GUI screen shown in more detail in FIG. 8D, the Inquire Carrier Financial (ICF) GUI screen shown in more detail in FIG. 8C, and the Inquire Carrier Notes (ICN) GUI screen, shown in more detail in FIG. 8B. Transaction code field 812 is linked to a table containing all transaction codes. The policy number field 814 represents the link to the owner of the policy. Debit and credit fields 818 and 820 indicate the amounts that are to be debited from or credited to the policy.

The exemplary GUI screen Inquire Carrier Notes (ICN) screen, shown in FIG. 8B is linked to the ICS screen shown in FIG. 8A via link 824. It also contains links to MCR GUI screen 804 and ICF GUI screen 806. The ICN GUI screen may be used, for example, if the carrier has a communication to the broker, which may be noted in the note field 826. An example of such communication may be an indication that there was a problem with payment receipt and/or processing. When the note in field 826 is created, it may be electronically distributed via, for example, an Exception Report, which may indicate that this is an actionable item, and that action needs to be taken to rectify the problem.

FIG. 8C shows the Inquire Carrier Financial (ICF) GUI screen. In addition to carrier ID field 802, this screen contains fields for routing number 832, bank account 834, account type 836 and name of bank 838.

FIG. 8D shows the Maintain Carrier Record (MCR) GUI screen, which relates to internal broker information regarding a partner carrier, including contact information 840, address information 842, other contact information, special instruction field (for special instructions, such as to send electronic and paper statements), and ACH instructions field 846.

Maintain Carrier Note GUI screen shown in FIG. 8E is related to ICN screen described above in reference to FIG. 8B, and contains an indication that action must be taken to resolve note 826.

It will be recognized by those of ordinary skill in the art that various levels of access (e.g., view-only and supervisor levels) may be needed to access and/or modify the information displayed in the exemplary GUI screens shown in FIGS. 8A-8E.

It will also be recognized by those of ordinary skill in the art that similar sets of GUI screens and/or forms may be created for other participating entities, such as employers and members. Employer-related GUI screens may include, for example, screens relating to employer financial information, records, contact information and statements among others.

Member-related GUI screens, for example, may include GUI screens for processing of member claims and reimbursement of HRA-approved claims (e.g., medical office co-pay deductibles, over-the-counter medications, prescription medication deductibles, and other approved expenses).

Referring now to FIG. 9, therein shown is an exemplary File Record Layout (FRL) file layout 900 for upload from an employer to a Financial Administrator, in accordance with an embodiment of the present invention. Employer Signup Keys 905 may include an Identification/Identifier ID, which acts to connect records in a database, such as a relational database, or other repository of data, a Social Security Number SSN 4, an Employer ID and an Employee ID. Employer Signup Basic 915 may include information such as the ID and contact information. Employer signup policy 925 may include information such as the ID, the policy type requested, the statement delivery and information on family members and their employers (if any). Employer Signup Banking 920 may include information such as the ID and bank account and routing information for one or more accounts. Employer Signup Charity may include information such as the ID and information relating to the charity.

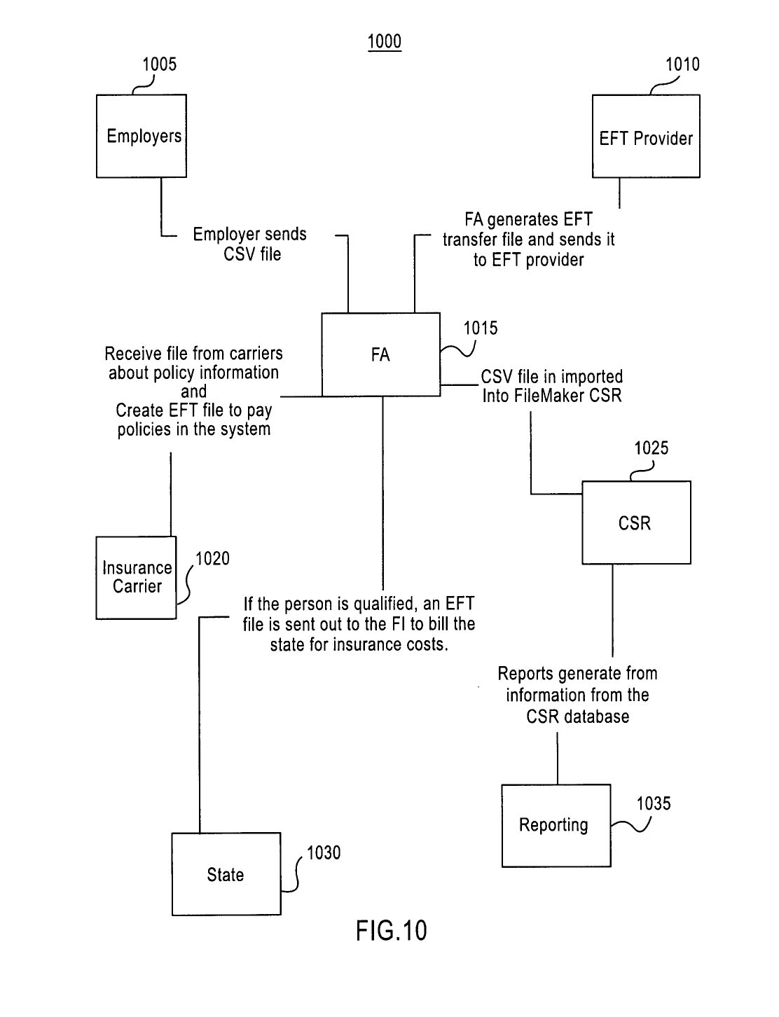

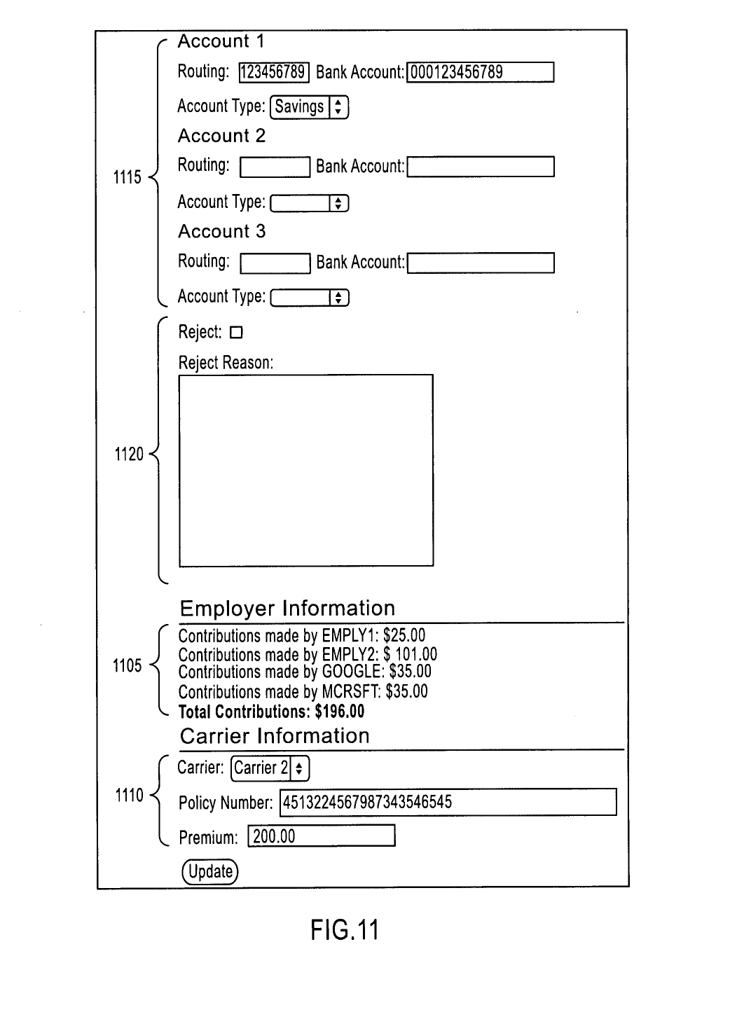

Referring now to FIG. 10, therein shown is an exemplary representative schematic 1000 depicting various entities relating to the functionality of an embodiment of the present invention, and the interfaces and connections among them. One or more employers 1005 periodically (e.g., monthly) transfer a FRL file (e.g., in CSV or XLS format), containing employee payroll detail to broker 1015 for processing. An exemplary FRL file is shown in FIG. 11. Referring again to FIG. 10, FA uploads the FRL file 1015 into database 1025, and maintains and updates the database 1025. Insurance carrier(s) 1020 transmit information regarding insurance policies and creation of EFT files (e.g., Automated Clearing House (ACH) files) for insurance policy payment 1020. FAgenerates 1015 EFT files for debiting, e.g., employers, employees, state and federal entities, and charities, and for crediting an insurance carrier. State may be billed 1030 for insurance costs, if the policy holder is qualified to receive assistance. Reports are generated 1035 based on the information in database 1025 for all entities.

Referring now to FIG. 11, therein shown is an exemplary GUI interface screen showing information for an exemplary insurance policy holder, in accordance with an embodiment of the present invention. Contributions made by each employer and/or other sources towards the policy holder's insurance premiums and the total amount of the contributions, are shown at 1105. Insurance carrier information, including the policy number and the premium amount, is shown at 1110. If the total contributions are not sufficient to cover the premium amount, the present invention may retrieve the difference from the policy holder's bank account(s) 1115 (e.g., checking, savings) to cover the difference. If the funds in the policy holder's account(s) are not sufficient to cover the difference, a rejection may be indicated at 1120. A rejection may also be indicated if the policy holder has not specified the correct information for debiting the account(s). If a rejection is indicated at 1120, another source of funding (e.g., relatives, charities, state/federal agencies) may be contacted to provide funding to cover the difference

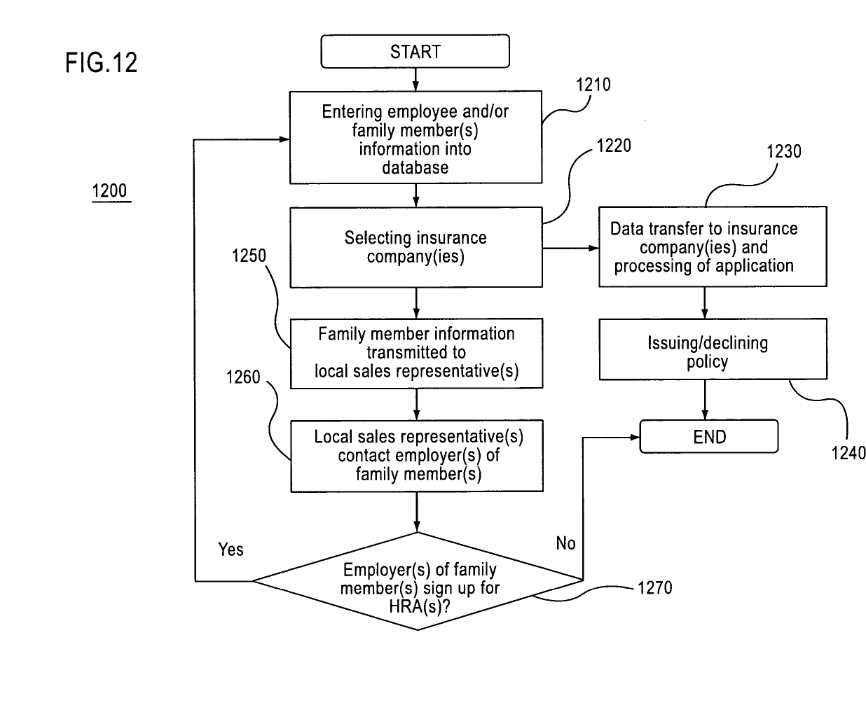

Referring now to FIG. 12, therein shown is an exemplary method 1200 for an employee-facilitated selection, sale and issuance of an insurance policy that best suits the employee's and the employee's family's needs and/or lifestyle.

Under the current state of the art, typically only licensed Insurance Brokers/Agents may approach employers with regards to health insurance. This limited contact to employers is especially constraining on small employers, as it drastically limits or eliminates small employers from the sales process, due to the limited commission revenue they provide to Insurance Brokers/Agents. Also affected are remote employers, located in areas where insurance is not provided in an efficient fashion, which may also be eliminated from the sales process.

Furthermore, healthcare insurance is generally undersold in the market place. All of these factors contribute to the increasing amount of uninsured in our healthcare system without, due to economic reasons, warranting the attention of the traditional Insurance Broker/Agent sales process.

According to one embodiment of the present invention, within a legal framework, any authorized sales person may contact Employers for the sole and express purpose of creating a funding mechanism for health insurance and other healthcare-related expenses. The funding mechanism, e.g., a HRA, allows an employer to provide funds for employees to purchase their own health insurance. Further, the authorized sales person can present contracts to the employer for employees' HRA(s), can assist the employer in obtaining financial information, and can respond to questions regarding the process of funding the HRA(s).

Once qualified, any person can provide information to the employer, prompt for contract execution, and guide the employer to complete the transaction, with the employer funding of the HRA(s) assigned to the employees for purchase of health insurance and/or other IRS Section 213(d) expenditures.

Employees may go to a website, call a toll-free number, or use any other mechanism for facilitating the selection, sale and issuance of an insurance policy that best meets the employees' and their families' needs and/or their lifestyles. Using a mechanism, such as a dedicated insurance website, employee information may be captured and stored in a database or other repository of data for transmission to the insurance company(ies) selected by the employee.

In the example shown in FIG. 12, the employees' information, along with information regarding their family member(s) is entered 1210. This information may, for example, include personal information and information regarding employer and employer contact information for the employee and each family member. This information is stored into a database or other data repository.

Facilitated by the employee, one or more insurance companies are selected 1220, e.g., from a list of insurance companies. The employee and/or family member data may be pre-populated in an insurance company form, or otherwise transmitted to the insurance company 1230. Each selected insurance company underwrites the information and decides to either issue a policy or decline the application 1240.

The employee's family member information (if any) is transmitted to a local sales or other authorized representative, e.g., based on area code or zip code, 1250. Upon receipt of the family member information, the authorized representative contacts the employer(s) of the family member(s) to offer products and/or services, e.g., with the goal of having the employer sign up for contributions to the family member(s') HRA 1270.

If the employer declines to sign up 1270, the process ends (or the employer may be contacted again within a period of time). If the employer signs up 1270, the method returns to entering the employee and/or family member information into database 1210.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

1. A method for providing multiple funding sources for approved healthcare expense reimbursement, the method comprising:
receiving, from a first one of at least one employer, agreement to create a Health Reimbursement Arrangement (HRA) for employee healthcare expense reimbursement;
receiving, from the first one of the at least one employer data regarding a first plurality of employees eligible for healthcare expense reimbursement;
funding a HRA for at least one of the first plurality of eligible employees with funds associated with the first one of the at least one employer; and
providing a healthcare expense reimbursement to the at least one of the first plurality of eligible employees from the funded HRA.

2. The method of claim 1, wherein the funds for the funded HRA are provided via an Automated Clearing House (ACH) transaction.

3. The method of claim 1, wherein the provided healthcare expense reimbursement is for a healthcare insurance premium.

4. The method of claim 1, further comprising:
generating a receipt for the first one of the at least one employer.

5. The method of claim 1, wherein the funds for the funded HRA are based on a criterion provided by the first one of the at least one employer.

6. The method of claim 1, further comprising:
upon a determination that the funded HRA contains insufficient funds to reimburse a healthcare expense of the at least one of the first plurality of eligible employees, obtaining additional funds to cover the difference.

7. The method of claim 6, wherein the additional funds are obtained from a source selected from a group consisting of the at least one of the first plurality of eligible employees, a relative of the at least one of the first plurality of eligible employees, a federal agency, a state agency, and a charitable organization.

8. The method of claim 1, further comprising:
funding the HRA for the at least one of the first plurality of eligible employees with funds associated with a second one of the at least one employer;
wherein the at least one of the first plurality of eligible employees is included in the second plurality of eligible employees.

9. The method of claim 8, further comprising:
generating a receipt for the second one of the at least one employer.

10. The method of claim 1, wherein the at least one of the first plurality of eligible employees retains the funded HRA after termination of employment with the first one of the at least one employer.

11. A system for providing access to multipile funding sources for approved healthcare expense reimbursement, the system comprising:
means for receiving, from a first one of at least one employer, agreement to create a Health Reimbursement Arrangement (HRA) for employee healthcare expense reimbursement;
means for receiving, from the first one of the at least one employer data regarding a first plurality of employees eligible for healthcare expense reimbursement;
means for funding a HRA for at least one of the first plurality of eligible employees with funds associated with the first one of the at least one employer; and
means for providing a healthcare expense reimbursement to the at least one of the first plurality of eligible employees from the funded HRA.

12. The system of claim 11, wherein the funds for the funded HRA are provided via an Automated Clearing House (ACH) transaction.

13. The system of claim 11, wherein the provided healthcare expense reimbursement is a healthcare insurance premium.

14. The system of claim 11, further comprising:
means for generating a receipt for the first one of the at least one employer.

15. The system of claim 11, wherein the funds for the funded HRA are based on a criterion provided by the first one of the at least one employer.

16. The system of claim 11, further comprising:
means for obtaining additional funds if a determination is made that the funded HRA contains insufficient funds to reimburse a healthcare expense of the at least one of the first plurality of eligible employees.

17. The system of claim 16, wherein the additional funds are obtained from a source selected from a group consisting of the at least one of the first plurality of eligible employees, a relative of the at least one of the first plurality of eligible employees, a federal agency, a state agency, and a charitable organization.

18. The system of claim 11, further comprising:
means for funding the HRA for the at least one of the first plurality of eligible employees with funds associated with a second one of the at least one employer;
wherein the at least one of the first plurality of eligible employees is included in the second plurality of eligible employees.

19. The system of claim 18, further comprising:
means for generating a receipt for the second one of the at least one employer.

20. The system of claim 11, wherein the at least one of the first plurality of eligible employees retains the funded HRA after termination of employment with the first one of the at least one employer.

21. A computer program product comprising a computer usable medium having control logic stored therein for causing a computer to provide access to multiple funding sources for approved healthcare expense reimbursement, the control logic comprising:
first computer readable program code means for receiving, from a first one of at least one employer, agreement to create a Health Reimbursement Arrangement (HRA) for employee healthcare expense reimbursement;
second computer readable program code means for receiving, from the first one of the at least one employer data regarding a first plurality of employees eligible for healthcare expense reimbursement;
third computer readable program code means for funding a HRA for at least one of the first plurality of eligible employees with funds associated with the first one of the at least one employer; and
fourth computer readable program code means for providing a healthcare expense reimbursement to the at least one of the first plurality of eligible employees from the funded HRA.

22. The computer program product of claim 21, wherein the funds for the funded HRA are provided via an Automated Clearing House (ACH) transaction.

23. The computer program product of claim 21, wherein the provided healthcare expense reimbursement is a healthcare insurance premium.

24. The computer program product of claim 21, the control logic further comprising:
fifth computer readable program code means for generating a receipt for the first one of the at least one employer.

25. The computer program product of claim 21, wherein the funds for the funded HRA are based on a criterion provided by the first one of the at least one employer.

26. The computer program product of claim 21, the control logic further comprising:
fifth computer readable program code means for obtaining additional funds if a determination is made that the funded HRA contains insufficient funds to reimburse a healthcare expense of the at least one of the first plurality of eligible employees.

27. The computer program product of claim 26, wherein the additional funds are obtained from a source selected from a group consisting of the at least one of the first plurality of eligible employees, a relative of the at least one of the first plurality of eligible employees, a federal agency, a state agency, and a charitable organization.

28. The computer program product of claim 21, the control logic further comprising:
fifth computer readable program code means for funding the HRA for the at least one of the first plurality of eligible employees with funds associated with a second one of the at least one employer;
wherein the at least one of the first plurality of eligible employees is included in the second plurality of eligible employees.

29. The computer program product of claim 28, the control logic further comprising:
sixth computer readable program code means for generating a receipt for the second one of the at least one employer.

30. The computer program product of claim 21, wherein the at least one of the first plurality of eligible employees retains the funded HRA after termination of employment with the first one of the at least one employer.

31. The method of claim 5, wherein the criterion is the number of hours worked by the at least one of the first plurality of eligible employees.

32. The method of claim 1, wherein the data includes a data transfer file.

33. The method of claim 32, wherein the data transfer file is one selected from a group consisting of a FRL file and a XML file.
